(19) United States
(12) Patent Application Publication
(10) Pub. No.: US 2012/0159785 A1
(43) Pub. Date: Jun. 28, 2012

(54) AUTOMATED PROCESSES FOR THE PRODUCTION OF POLYURETHANE WIND TURBINE BLADES

(75) Inventors: Robert A. Pyles, Bethel Park, PA (US); Joel Matsco, Coraopolis, PA (US)

(73) Assignee: BayerMaerialScience LLC, Pittsburgh, PA (US)

(21) Appl. No.: 13/392,967

(22) PCT Filed: Sep. 1, 2010
(86) PCT No.: PCT/US10/02388

§ 371 Date: Feb. 28, 2012

Related U.S. Application Data
(60) Provisional application No. 61/239,885, filed on Sep. 4, 2009.

(51) Int. Cl. B23P 15/02

(52) U.S. Cl. 29/889.7

(57) ABSTRACT

The present invention provides processes for the production of polyurethane wind turbine blades and other large objects. The inventive process involves forming a mold for the polyurethane wind turbine blade at a wind farm site, injecting an isocyanate and an isocyanate-reactive component with an automated reaction injection molding (“RIM”) machine into the mold, closing, pressing and heating the mold to cure the resulting polyurethane and installing the polyurethane blade in the wind turbine. Alternatively, the process involves forming a mold for polyurethane wind turbine blade at a wind farm site, injecting an isocyanate, an isocyanate-reactive component and long fibers with an automated long fiber injection (“LFI”) machine, closing, pressing and heating the mold to cure the resulting polyurethane and installing the polyurethane blade in the wind turbine. Because the inventive manufacturing process occurs at the wind farm site, transportation problems are obviated.

### FIELD OF THE INVENTION

The present invention relates in general to, manufacturing processes and more specifically to, an automated process for the on-site production of wind turbine blades and other large objects.

### BACKGROUND OF THE INVENTION

As the desire to reduce electrical power generation from imported fossil fuels continues to grow duc to environmental and political concerns, wind power is assuming an increasing role in the generation of electricity. A 2008 report entitled “20% Wind Energy by 2030: Increasing Wind Energy's Contribution to U.S. Electricity Supply”, was issued by the U.S. Department of Energy (“DOE”) which examined the technical feasibility of using wind energy to generate 20% of the nation's electricity demand by 2030. World wide, a number of countries already generate significant amounts of their electricity from the wind. According to the “Global Wind 2008 Report”, issued by the Global Wind Energy Council (“GWEC”), Spain currently satisfies 11% and Germany about 7.5%, of their electrical demands from wind power. The European Union has a target of renewable resources providing approximately 35% of its electrical power by 2020 with about one-third of that being wind energy.

As the demand for wind power capacity grows, so too does the size of the generators, i.e., the wind turbine. The size and weight of the turbine blades also grows proportionally. Larger blades (possibly up to 90 meters long or more) become more difficult to fabricate and heavier. Also, the towers needed to house the turbine and support the blades must be larger and consequently more difficult to erect. Because these larger turbines will likely be located in more remote areas, transportation of the larger, heavier blades becomes a concern. These factors may combine to limit the fullest utilization of wind power as a viable renewable resource. A number of those in the art have attempted to deal with the issues related to larger blades with varying degrees of success.

For example, Lin et al., in US Published Patent Application No. 2006/225278 disclose a two facility process in which primary components such as the root and spar caps are fabricated at a primary facility, secondary blade components such as skins are made at a secondary facility located closer to the wind farm location, and then primary and secondary components are assembled in an assembly location near the wind farm. US Published Patent Application No. 2008/0145231 in the name of Llorente Gonzales et al. shows wind blade modules joined via flanges at the ends of an inner longitudinal reinforcing structure. Axially projecting lugs are abutted facing each other, with holes aligned to receive attachment screws, through-bolts or rivets for supposed easy attachment of modules in the field.

U.S. Pat. No. 7,334,989 issued to Arelt teaches use of top and bottom bands with corresponding wedge-shaped connection areas applied to consecutive blade segments. A hollow space remaining between the blade segments and connecting bands is flooded with adhesive, resulting in a bonded joint formed by multiple scarf/taper joints along primary load paths. Arelt also discloses wedge-shaped connection areas fabricated into consecutive blade segments, which are then connected to and by top and bottom bands with corresponding wedge-shaped connection areas to form bonded taper joints along primary load paths once the hollow area between bands and blade connection areas is flooded with adhesive.

Moroz in U.S. Pat. No. 7,381,029 provides a multisection blade for a wind turbine which includes a hub extender having a pitch bearing at one end, a skirt or fairing having a hole there through and configured to mount over the hub extender, and an outboard section configured to couple to the pitch bearing.

Therefore, a need exists in the art for improved manufacturing processes for wind turbine blades and other large objects. The processes should minimize or eliminate transportation problems with the construction of blades as seen in the current art methods.

### SUMMARY OF THE INVENTION

Accordingly, the present invention provides processes for the production of polyurethane wind turbine blades and other large objects. The inventive process involves forming a mold for the wind turbine blade at or near a wind farm site, injecting isocyanate and isocyanate reactive component with an automated reaction injection molding (“RIM”) machine into the mold, closing, pressing and heating the mold to cure the resulting polyurethane and installing the polyurethane blade in the wind turbine. Also, the process involves forming a wind turbine blade mold at or near a wind farm site, injecting isocyanate, isocyanate reactive component and long fibers with an automated long fiber injection (“LFI”) machine, closing, pressing and heating the mold (or utilizing radiation, such as UV light) to cure the resulting polyurethane and installing the polyurethane blade in the wind turbine. Because the inventive manufacturing process occurs at or near the wind farm site, transportation problems may be obviated.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows a schematic of robotic crafting of molds and wind turbine towers;

FIG. 2 illustrates an example of robotic crafting of wind turbine tower base; and

FIG. 3 depicts an automated process for producing large parts.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a process for the production of a polyurethane wind turbine blade involving forming a mold for the wind turbine blade at or near a wind farm site, injecting an isocyanate and an isocyanate reactive component with an automated reaction injection molding (“RIM”) machine into the mold, closing, pressing and heating the mold to cure the resulting polyurethane and installing the polyurethane blade in the wind turbine. Preferably, the polyurethane material may be cured using radiation, such as UV-radiation.

The present invention further provides a process for the production of a polyurethane wind turbine blade involving forming a wind turbine blade mold at or near a wind farm site, injecting an isocyanate, an isocyanate reactive component and long fibers with an automated long fiber injection (“LFI”) machine, closing, pressing and heating the mold to cure the resulting polyurethane and installing the polyurethane blade into the wind turbine. Preferably, the polyurethane is cured using radiation.

The wind turbine blade mold may be formed at or near the wind farm site by large scale rapid prototyping, by additive automated fabrication or by fabricating a positive image of the wind turbine blade with large scale rapid prototyping, forming a negative image and casting or molding a high strength composite. The high strength composite may include at least one of metal, cement and polymer.

The processes of the present invention may produce the wind turbine blade by either an automated reaction injection molding (“RIM”) process or by an automated long fiber injection (“LFI”) process.

The production of polyurethane moldings via the RIM technique is well known and described in, for example, U.S. Pat. No. 4,218,543, the contents of which are incorporated by reference. The RIM process involves a technique of filling the mold by which highly reactive, liquid starting components are injected into the mold within a very short time by means of a high output, high pressure dosing apparatus after they have been mixed in so-called “positively controlled mixing heads”. In a RIM process, two separate streams are intimately mixed and subsequently injected into a suitable mold, although it is possible to use more than two streams. The first stream contains the polyisocyanate component, while the second stream contains the isocyanate reactive components and any other additive which is to be included. The RIM process is also detailed in U.S. Pat. Nos. 5,750,583; 5,973,099; 5,668,239; 5,470,523, the entire contents of which are incorporated by reference.

In the LFI process, an open mold is charged from a mixhead in which fiberglass strands cut from the roving and the polyurethane reaction mixtures are combined. The volume and length of the glass fibers can be adjusted at the mixhead. This process uses lower cost fiberglass roving rather than mats or preforms. The glass roving is preferably fed to a mixhead equipped with a glass chopper. The mixhead simultaneously dispenses the polyurethane reaction mixture and chops the glass roving as the mixhead is positioned over the mold and the contents of the mixhead are dispensed into the open mold. When the contents of the mixhead have been dispensed into the mold, the mold is closed, the reaction mixture is allowed to cure and the composite article is removed from the mold. The mold is preferably maintained at a temperature of from about 120 to 190° F. The time needed to dispense the contents of the mixhead into the mold will usually be between 10 and 60 seconds. The mold preferably remains closed for a period of from about 1.5 to about 6 minutes to allow the glass fiber reinforced layer to cure.

Long fiber injection is described in US Published Patent Application Nos. 2005/0170189, 2007/0098997 2004/0135280, 2007/0160793, 2008/0058468, the entire contents of which are incorporated herein by reference.

The thermoset plastic materials and/or thermoplastic materials from which the article may be fabricated, may optionally be reinforced with a material selected from continuous glass strands, continuous glass mats, carbon fibers, carbon mats, boron fibers, carbon nanotubes, metal flakes, polyamide fibers (e.g., KEVLAR polyamide fibers) and mixtures thereof. The reinforcing materials, and the glass fibers in particular, may have sizings on their surfaces to improve miscibility and/or adhesion to the plastics into which they are incorporated, as is known to the skilled artisan. Glass fibers are a preferred reinforcing material in the present invention. If used, the reinforcement material, e.g., glass fibers, is preferably present in the thermoset plastic materials and/or thermoplastic materials of the article in a reinforcing amount, e.g., in an amount of from 5 percent by weight to 75 percent by weight, based on the total weight of the article. The long fibers useful in the present invention are preferably more than 3 mm, more preferably more than 10 mm, and most preferably from 12 mm to 75 mm in length.

The long fibers preferably make up from 5 to 75 wt. %, more preferably from 10 to 60 wt. %, and most preferably from 20 to 50 wt. % of the long fiber-reinforced polyurethane. The long fibers may be present in the long fiber-reinforced polyurethanes of the present invention in an amount ranging between any combination of these values, inclusive of the recited values.

As those skilled in the art are aware, polyurethanes are the reaction products of polyisocyanates with isocyanate-reactive compounds, optionally in the presence of blowing agents, catalysts, auxiliaries and additives.

Suitable as isocyanates for the long fiber reinforced polyurethanes of the present invention include unmodified isocyanates, modified polyisocyanates, and isocyanate prepolymcrs. Such organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Examples of such isocyanates include those represented by the formula

Q(NCO)ₙ

in which n is a number from 2-5, preferably 2-3, and Q is an aliphatic hydrocarbon group containing 2-18, preferably 6-10, carbon atoms; a cycloaliphatic hydrocarbon group containing 4-15, preferably 5-10, carbon atoms; an araliphatic hydrocarbon group containing 8-15, preferably 8-13, carbon atoms; or an aromatic hydrocarbon group containing 6-15, preferably 6-13, carbon atoms.

Examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophoronc diisocyanate; e.g., German Auslegeschrift 1,202,785 and U.S. Pat. No. 3,401,190); 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI), which are described, for example, in GB 878,430 and GB 848,671; norbornane diisocyanates, such as described in U.S. Pat. No. 3,492,330; m- and p-isocyanatophenyl sulfonylisocyanates of the type described in U.S. Pat. No. 3,454,606; perchlorinated aryl polyisocyanates of the type described, for example, in U.S. Pat. No. 3,227,138; modified polyisocyanates containing carbodiimide groups of the type described in U.S. Pat. No. 3,152,162; modified polyisocyanates containing urethane groups of the type described, for example, in U.S. Pat. Nos. 3,394,164 and 3,644,457; modified polyisocyanates containing allophanate groups of the type described, for example, in GB 994,890, BE 761,616, and NL 7,102,524; modified polyisocyanates containing isocyanurate groups of the type described, for example, in U.S. Pat. No. 3,002,973, German Patentschriften 1,022,789, 1,222,067 and 1,027,394, and German Offenlegungsschriften 1,919,034 and 2,004,048; modified polyisocyanates containing urea groups of the type described in German Patentschrift 1,230,778; polyisocyanates containing biuret groups of the type described, for example, in German Patentschrift 1,101,394, U.S. Pat. Nos. 3,124,605 and 3,201,372, and in GB 889,050; polyisocyanates obtained by telomerization reactions of the type described, for example, in U.S. Pat. No. 3,654,106; polyisocyanates containing ester groups of the type described, for example, in GB 965,474 and GB 1,072,956, in U.S. Pat. No. 3,567,763, and in German Patentschrift 1,231,688; reaction products of the above-mentioned isocyanates with acetals as described in German Patentschrift 1,072,385; and polyisocyanates containing polymeric fatty acid groups of the type described in U.S. Pat. No. 3,455,883. It is also possible to use the isocyanate-containing distillation residues accumulating in the production of isocyanates on a commercial scale, optionally in solution in one or more of the polyisocyanates mentioned above. Those skilled in the art will recognize that it is also possible to use mixtures of the polyisocyanates described above.

Isocyanate-terminated prepolymers may also be employed in the preparation of the polyurethanes of the present composite. Prepolymers may be prepared by reacting an excess of organic polyisocyanate or mixtures thereof with a minor amount of an active hydrogen-containing compound as determined by the well-known Zerewitinoff test, as described by Kohler in Journal of the American Chemical Society, 49, 3181 (1927). These compounds and their methods of preparation are well known to those skilled in the art. The use of any one specific active hydrogen compound is not critical; any such compound can be employed in the practice of the present invention.

Although any isocyanate-reactive compound may be used to produce the polyurethanes, polyether polyols are preferred as isocyanate-reactive components. Suitable methods for preparing polyether polyols are known and are described, for example, in EP-A 283 148, U.S. Pat. Nos. 3,278,457; 3,427,256; 3,829,505; 4,472,560; 3,278,458; 3,427,334; 3,941,849; 4,721,818; 3,278,459; 3,427,335; and 4,355,188.

Suitable polyether polyols may be used such as those resulting from the polymerization of a polyhydric alcohol and an alkylene oxide. Examples of such alcohols include ethylene glycol, propylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, or 1,2,6-hexanetriol. Any suitable alkylene oxide may be used such as ethylene oxide, propylene oxide, butylene oxide, amylene oxide, and mixtures of these oxides. Polyoxyalkylene polyether polyols may be prepared from other starting materials such as tetrahydrofuran and alkylene oxide-tetrahydrofuran mixtures, epihalohydrins such as epichlorohydrin, as well as aralkylene oxides such as styrene oxide. The polyoxyalkylene polyether polyols may have either primary or secondary hydroxyl groups. Included among the polyether polyols are polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols and copolymer glycols prepared from blends or sequential addition of two or more alkylene oxides. The polyoxyalkylene polyether polyols may be prepared by any known process.

Blowing agents which can be included are compounds with a chemical or physical action which are known to produce foamed products. Water is a particularly preferred example of a chemical blowing agent. Examples of physical blowing agents include inert (cyclo)aliphatic hydrocarbons having from 4 to 8 carbon atoms, which evaporate under the conditions of polyurethane formation. The amount of blowing agents used is guided by the target density of the foams.

As catalysts for polyurethane formation, it is possible to use those compounds which accelerate the reaction of the isocyanate with the isocyanate-reactive component. Suitable catalysts for use in the present invention include tertiary amines and/or organometallic compounds. Examples of compounds include the following: triethylenediamine, aminoalkyl- and/or aminophenyl-imidazoles, e.g. 4-chloro-2,5-dimethyl-1-(N-methylaminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole and/or 1-(3-aminopropyl)-2-methylimidazole, tin(II) salts of organic carboxylic acids, examples being tin(II) diacetate, tin(II) dioctoate, tin(II) diethylhexoate, and tin(II) dilaurate, and dialkyltin(IV) salts of organic carboxylic acids, examples being dibutyltin diacetate, dibutyltin dilaurate, dibutyltin maleate and dioctyltin diacetate.

The polyurethane forming reaction may take place, if desired, in the presence of auxiliaries and/or additives, such as cell regulators, release agents, pigments, surface-active compounds and/or stabilizers to counter oxidative, thermal or microbial degradation or aging.

The diisocyanate and polyol mixtures may optionally be UV curable and composed of UV curable components containing mono-, di-, or polyfunctional ethylenic unsaturated groups or multi-functional epoxide groups. The UV curable components may be in liquid or solid forms. Examples of ethylenic unsaturated compounds include styrenic derivatives, vinyl ether, vinyl ester, allyl ether, allyl ester, N-vinyl caprolactam, N-vinyl caprolacton, acrylate, or methacrylate monomers. The examples of such compounds may also include oligomers of epoxy acrylates, urethane acrylates, unsaturated polyesters, polyester acrylates, polyether acrylates, vinyl acrylates and polyene/thiol systems. The most commonly used UV curable components contain the acrylate unsaturation groups. The backbone structures of acrylate compounds include aliphatic, cycloaliphatic, aromatic, alkosylated, polyols, polyester, polyether, silicone, and polyurethane. The UV curable ethylenic unsaturated components may be polymerized via free radical polymerization initiated by a photoinitiator upon exposure to radiation source, e.g. UV radiation. The ethylenic unsaturated groups are consumed during the polymerization process and the degree of unsaturated groups conversion is a measure of the degree of cure. The multi-functional epoxide compounds can be polymerized via cationic polymerization initiated by a photogenerated active species upon exposure to radiation source, e.g. UV radiation. However, cationic UV curing is not restricted to epoxide. The radiation-curable components preferably have a weight average molecular weight ranging from 100 to 10,000, and more preferably in a range from 400 to 4,000. The degree of unsaturation or epoxy group ranges from 2 to 30% by weight. Depending on specific application and final cured image properties, the weight ratio of UV curable components to non-reactive polymer binders may preferably range from 0.1 to 100 percent.

One embodiment of the present invention includes a photoinitiator and/or a co-initiator that is chosen from those commonly used for radiation curing purposes. The appropriate photoinitiators which can be useful in the present invention are direct cleavage (Norrish Type I or II) photoinitiators including benzoin and its derivatives, benzil ketals and its derivatives, acetophenone and its derivatives, hydrogen abstraction photoinitiators including benzophenone and its alkylated or halogenated derivatives, anthraquinone and its derivatives, thioxanthone and its derivatives, and Michler's ketone. Examples of suitable photoinitators are benxophenone, chlorobenzophenone, 4-benzoyl-4′-methyldiphenyl sulphide, acrylated benzophenone, 4-phenyl benzophenone, 2-chlorothioxanthone, isopropyl thioxanthone, 2,4-dimethyl thioxanthone, 2,4 dichlorothioxanthone, 3,3′-dimthyl-4-methoxybenzophenone, 2,4-diethylthioxanthone, 2,2-diethoxyacetophenone, α,α-dichloroaceto, p-phenoxyphenone, 1-hydroxycyclohexyl acetophenone, α, α-dimethyl, α-hydroxy acetophenone, benzoin, benzoin ethers, benzyl ketals, 4,4′-dimethyl amino-benzophenone, 1-phenyl-1,2-propane dione-2 (O-ethoxy carbonyl)oxime, acylphosphine oxide, 9,10-phenanthrene quinine, and the like. It may be beneficial to use photosensitizers in combination with a radical generating initiator, wherein the sensitizer absorbs light energy and transfers it to the initiator. Examples of photosensitizers include thioxanthone derivatives and tertiary amines, such as triethanolamine, methyl diethanolamine, ethyl 4-dimethyl aminobenzoate, 2(n-butoxy)ethyl 4-dimethylamino benzoate, 2-ethyl hexyl p-dimethyl-aminobenzoate, amyl p-dimethyl-aminobenzoate and tri-isopropanolamine. Photoinitiated cationic polymerization uses salts of complex organic molecules to initiate cationic chain polymerization in oligomers or monomers containing epoxides. Cationic photoinitiators include, but are not limited to diaryliodonium and triarylsulfonium salts with non-nucleophilic complex metal halide anions. Examples of cationic photoinitiators are aryldiazonium salts of the general formula Ar—N₂^{+X-}, wherein Ar is an aromatic ring such as butyl benzene, nitrobenzene, dinitrobenzene, or the like and X is BF₄, PF₆, AsF₆, SbF₆, CF₃SO₃, or the like; diaryliodonium salts of the general formula Ar₂I^{+X-}, wherein Ar is an aromatic ring such as methoxy benzene, butyl benzene, butoxy benzene, octyl benzene, didecyl benzene, or the like, and X is an ion of low nucleophilicity, such as BF₄, PF₆, AsF₆, SbF₆, CF₃SO₃, and the like; triarylsulfonium salts of the general formula Ar₃S^{+X-}, wherein Ar is an aromatic ring such as hydroxy benzene, methoxy benzene, butyl benzene, butoxy benzene, octyl benzene, dodecyl benzene, or the like and X is an ion of low nucleophilicity, such as BE₄, PF₆, AsF₆, SbF₆, CF₃SO₃, or the like. These compositions may contain 0.1-20% by weight of photoinitiators, and preferably contain 1 to 10% by weight. UV curing technology via radical polymerization and cationic polymerization are well known. The UV curing materials and processes are reviewed in, for example, “UV & EB Curing Technology & Equipment Volume I” by R. Mehnert, A. Pincus, I. Janorsky, R. Stowe and A. Berejka, the contents of which are incorporated by reference.

Optionally, pigments can be dispersed in the polymer, insoluble in water and yield strong permanent color. Examples of such pigments are the organic pigments such as phthalocyanines, lithols and the like and inorganic pigments such as TiO₂, carbon black, and the like. Examples of the phthalocyanine pigments are copper phthalocyanine, a mono-chloro copper phthalocyanine, and hexadecachloro copper phthalocyanine. Other organic pigments suitable for use herein include anthraquinone vat pigments such as vat yellow 6GLCL1127, quinone yellow 18-1, indanthrone CL1106, pyranthrone CL1096, brominated pyranthrones such as dibromopyranthrone, vat brilliant orange RK, anthramide brown CL1151, dibenzanthrone green CL1101, flavanthrone yellow CL1118; azo pigments such as toluidine red C169 and hansa yellow; and metallized pigments such as azo yellow and permanent red. The carbon black may be any of the known types such as channel black, furnace black, acetylene black, thermal black, lamp black, and aniline black. The pigments are preferably employed in an amount sufficient to give a content thereof from 1% to 40%, by weight, based upon the weight of the article, and more preferably within the range of 4% to 20%, by weight.

A thermoplastic material for producing blow molded rigid hollow articles may be selected independently. In an embodiment of the present invention, the thermoplastic material of blow molded rigid hollow article is selected from at least one of thermoplastic polyolefins (e.g., thermoplastic polyvinylchloride), thermoplastic polyvinylchlorine, thermoplastic polyurethanes, thermoplastic polyureas, thermoplastic polyamides, thermoplastic polyesters and thermoplastic polycarbonates. Thermoplastic polyolefins from which the blow molded rigid hollow articles may be fabricated include, for example, thermoplastic polyethylene, thermoplastic polypropylene, thermoplastic copolymers of ethylene and propylene, and thermoplastic polybutylene. In one embodiment of the present invention, blow molded rigid hollow article is fabricated from thermoplastic polyamide (e.g., DURETHAN thermoplastic polyamide), commercially available from LANXESS.

As used herein, the term “thermoset plastic material” means plastic materials having a three dimensional crosslinked network resulting from the formation of covalent bonds between chemically reactive groups, e.g., active hydrogen groups and free isocyanate groups. Thermoset plastic materials from which the support may be fabricated include those known to the skilled artisan, e.g., crosslinked polyurethanes, crosslinked polyepoxides and crosslinked polyesters. Of the thermoset plastic materials, crosslinked polyurethanes are preferred. The article may be fabricated from crosslinked polyurethanes by the art-recognized process of reaction injection molding. Reaction injection molding typically involves, as is known to the skilled artisan, injecting separately, and preferably simultaneously, into a mold: (i) an active hydrogen functional component (e.g., a polyol and/or polyamine); and (ii) an isocyanate functional component (e.g., a diisocyanate such as toluene diisocyanate, and/or dimers and trimers of a diisocyanate such as toluene diisocyanate). The filled mold may optionally be heated to ensure and/or hasten complete reaction of the injected components. Upon complete reaction of the injected components, the mold is opened and the molded article is removed.

Filling materials, such as polymer foams, liquid and liquid gels may be introduced into the hollow articles during or after the molding process, to instill additional support to the member, as is know to the skilled artisan.

In an embodiment of the present invention, blades or other large parts may have an integral texture on at least a portion of its outer surface, to provide advantages in blade efficiencies by altering the surface and subsequent aerodynamics. The integral texture can be imparted using several techniques, including textured films, a textured mold and/or coatings.

The integral textured film is formed on the outer surface by means of an in-mold process. The integral film is typically a plastic film, e.g., a thermoplastic or thermoset plastic film, and may be clear, tinted or opaque and textured. Additionally, the integral film may have indicia, patterns and/or printing thereon. Preferably, the integral film is a thermoplastic film, e.g., a thermoplastic polyurethane or polycarbonate film. The integral film preferably incorporated into the outer surface during the molding process, i.e., by means of an in-mold process. As an example, a thermoplastic polyurethane film insert, is preferably placed in contact with at least a portion of the interior surface of the mold. During the molding process, the molten molding material, composing the article, contacts and becomes fused with the film insert. Upon removal of the article from the mold, the part has an integral textured film adhered to at least a portion of its outer surface.

Alternatively, the exterior surface of the article may have molded-in texture. Molded-in texture can serve to provide advantages in blade efficiencies by changing blade aerodynamics. The molded-in texture may be preferably formed by a plurality of raised portions and/or recesses on and/or in the interior surface of the mold in which blade is formed. Optionally, a coating may be added to the mold surface as a means to enhance the molded-in texture and/or to aid the removal of the article from the mold.

Various methods have been proposed for forming three-dimensional objects by deposition of layers of material on a substrate. This layered manufacturing process is also known as solid free-form fabrication (SFF) or rapid prototyping (RP). Various materials and combinations of materials can be processed according to this method, including materials such as plastics, waxes, metals, ceramics, cements, and the like. In general, RP techniques build three-dimensional objects, layer-by-layer, from a building medium using data representing successive cross-sections of the object to be formed. Computer Aided Design and Computer Aided Manufacturing systems, often referred to as CAD/CAM systems, typically provide the object representation to an RP system. The three primary modes of rapid prototyping and manufacturing (RP&M) include stereolithography, laser sintering, and ink jet printing of solid images.

Laser sintering builds solid images from thin layers of heat-fusible powders, including ceramics, polymers, and polymer-coated metals to which sufficient energy is imparted to solidify the layers. Ink jet printing builds solid images from powders that are solidified when combined with a binder. Stereolithography, to which the present invention is primarily addressed, builds solid images from thin layers of polymerizable liquid, commonly referred to as resin.

Additive automated fabrication techniques are described by Khoshevis in U.S. Pat. Nos. 5,529,471; 5,656,230; 6,589,471; 7,153,454 and 7,452,196 and in US Published Patent Application Nos. 2005/0196482; 2007/0138678; 2007/0138687 and 2007/0181519, the contents of which are incorporated herein by reference.

Although the present invention is described herein in the context of producing wind turbine blades, the inventors contemplate that the processes could be used in the production of a wide variety of other large objects including wind turbine towers, automotive structural panels, panels for agricultural harvesting machinery (i.e., combines), composite structures for airliners, panels used in building and construction (e.g., cubicles) and large refuse bins.

### Examples

The present invention is further illustrated, but is not to be limited, by the following examples.

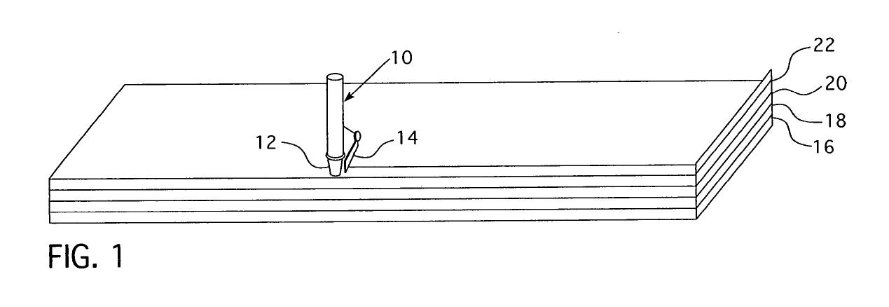

FIG. 1 illustrates the use of an automated system to produce concrete molds for manufacturing very large parts, like, for example, wind turbine blades. Such substantial molds provide the necessary stability and rigid structures so critical for successfully replicating these giant parts. Additionally, these molds can be conveniently produced at or near the wind turbine manufacturing site, and relatively inexpensively.

As can be appreciated by reference to FIG. 1, the mold-forming process involves the use of a material feed tube 10 fitted with an extruder die 12 to deliver concrete, in a controlled manner, to manufacture the mold layer by layer. The extruder tube and die combination are computer guided. To develop the necessary computer model, the mold is designed using CAD (computer aided design) software. Subsequently, the design data is transferred and used to program the CAM (computer aided manufacturing) computer. The CAM computer (not shown) directs the material feed tube 10 and extruder die 12 combination to form the mold layer by layer, as illustrated. As the layers 16, 18, 20 and 22 are laid down, a trowel 14, which is integrated with the feed tube 10 and computer controlled as well, smoothes the top and sides of the extruded concrete. Heating elements are inserted during the mold construction process, and the finished mold is equipped with a tight fitting lid, which was also heated.

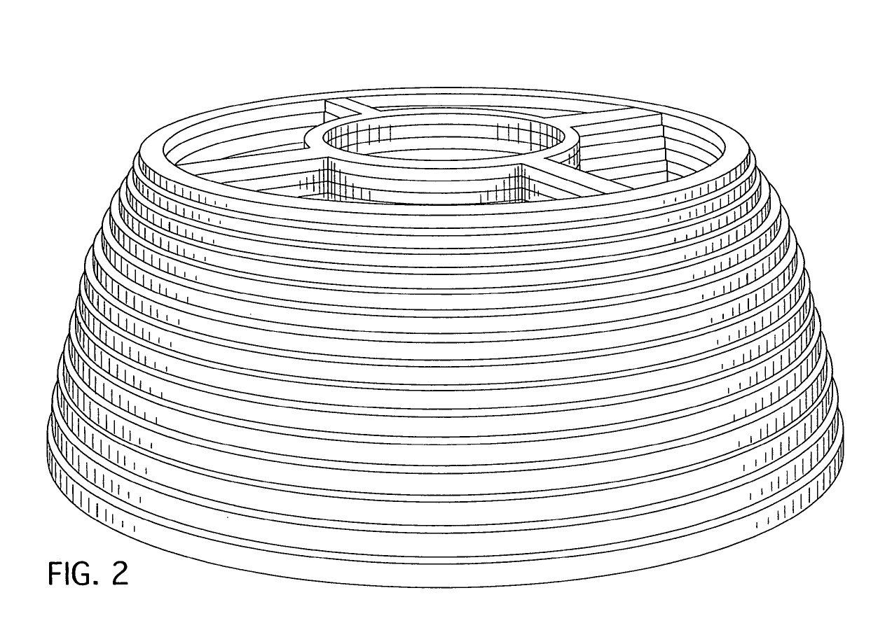

FIG. 2 illustrates the wind turbine tower base, under construction, using the automated system described in conjunction with FIG. 1. Reinforcement rods may be inserted, as necessary, during the construction phase to provide additional structural strength.

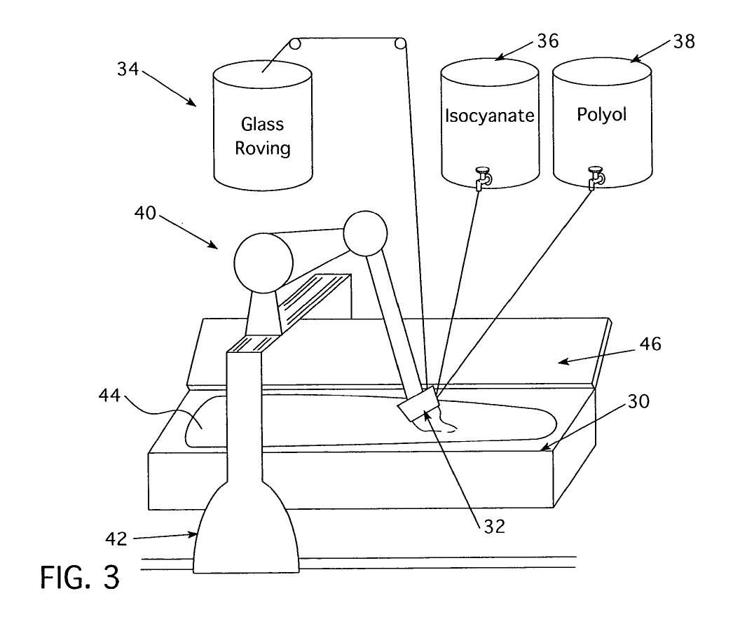

Referencing FIG. 3, the open mold 30 is charged from a mixhead 32 (e.g. from Krauss-Maffei). At the mixhead 32, fiberglass strands are cut into appropriate lengths from the glass roving 34, and concurrently, individual polyurethane components, pumped from the holding tanks isocyanate 36 and polyol 38, are combined. The mixhead 32 simultaneously dispenses the polyurethane reaction mixture and chopped the glass roving as the mixhead 32 continuously passes over the open mold 30. The distribution of the polyurethane reaction mixture and the glass fibers over the mold 30 surface is controlled by the robot 40 attached to the computer-controlled gantry 42. As illustrated, the gantry 42 is mounted on tracks allowing the robot 40 to move freely, and consequently, to completely cover the mold cavity 44. The cavity 44 is filled, and subsequently, the mold lid 46 is closed. The mold 30 remains closed for a period of from about 1.5 to about 6 minutes to allow the glass fiber reinforced layer to cure at a temperature of from about 120 to 190° F. A mold release agent is used to assure acceptable demolding of the composite article. The time needed to dispense the contents of the mixhead 32 into the mold 30 is about 60 seconds.

The foregoing example of the present invention is offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A process for manufacturing a polyurethane wind turbine blade comprising:
forming a mold for the wind turbine blade at or near a wind farm site;
injecting an isocyanate and an isocyanate reactive-component with an automated reaction injection molding (“RIM”) machine into the mold;
closing, pressing and heating the mold to cure the resulting polyurethane; and
installing the blade into the wind turbine.

2. The process according to claim 1, wherein the polyurethane is cured using radiation.

3. The process according to claim 1, wherein the forming is accomplished by large scale rapid prototyping.

4. The process according to claim 1, wherein the forming is accomplished by additive automated fabrication.

5. The process according to claim 1, wherein the forming comprises fabricating a positive image of the wind turbine blade with large scale rapid prototyping, forming a negative image and casting or molding a high strength composite.

6. The process according to claim 4, wherein the high strength composite comprises at least one of metal, cement and polymer.

7. A process for manufacturing a polyurethane wind turbine blade comprising:
forming a wind turbine blade mold at or near a wind farm site;
injecting an isocyanate, an isocyanate-reactive component and long fibers with an automated long fiber injection (“LFI”) machine;
closing, pressing and heating the mold to cure the resulting polyurethane; and
installing the blade into the wind turbine.

8. The process in claim 7, wherein the polyurethane is cured using radiation.

9. The process according to claim 7, wherein the forming is accomplished by large scale rapid prototyping.

10. The process according to claim 7, wherein the forming is accomplished by additive automated fabrication.

11. The process according to claim 7, wherein forming comprises fabricating a positive image of the wind turbine blade with large scale rapid prototyping, forming a negative image and casting or molding a high strength composite.

12. The process according to claim 11, wherein the high strength composite comprises one or more selected from metal, cement and polymer.
